(19) United States
(12) Patent Application Publication
(10) Pub. No.: US 2026/0035974 A1
(43) Pub. Date: Feb. 5, 2026

(54) GUIDE SYSTEM FOR MOVABLY SUPPORTING AT LEAST ONE COVER ELEMENT FOR COVERING AN OPENING IN A STATIONARY STRUCTURE

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (DE); Alexander Simon FLOGAUS, Eriskirch (DE)

(21) Appl. No.: 19/355,029

(22) Filed: Oct. 10, 2025

Related U.S. Application Data
(63) Continuation of application No. PCT/AT2024/060136, filed on Apr. 10, 2024.

(30) Foreign Application Priority Data
Apr. 12, 2023 (AT) 50262/2023

(51) Int. Cl. E05D 15/10; E05F 15/632

(52) U.S. Cl. CPC E05D 15/1013; E05F 15/632; E05D 2015/1031; E05Y 2201/654; E05Y 2900/148

(57) ABSTRACT

A guide system for movably supporting a cover element for covering an opening in a stationary structure includes a first assembly for arranging on the stationary structure and second assembly for arranging on the cover element. A first guide device allows the two assemblies to be moved relative to each other in a first movement direction, and a second guide device allows the two assemblies to be moved relative to each other in a second movement direction that is transverse, in particular orthogonal, to the first movement direction. A blocking device can be arranged in a blocking position in which a movement of the second assembly along the second movement direction can be braked and/or blocked, and in a release position, in which a movement of the second assembly along the second movement direction is substantially uninfluenced by the blocking device.

The present application is a continuation of International Application PCT/AT2024/060136 filed on Apr. 10, 2024. Thus, all of the subject matter of International Application PCT/AT2024/060136 is incorporated herein by reference.

### BACKGROUND OF THE INVENTION

The present invention relates to a guide system, an arrangement with such a guide system, and a method for covering and opening at least one opening in a stationary structure by means of at least one cover element.

Guide systems are used for a wide variety of applications. For example, guide systems can support two or more assemblies in a movable manner relative to one another via rail devices and/or joint devices.

A common application of a guide system is, for example, the movable support of cover elements such as windows, doors or panels in stationary structures such as wall elements. Such guide systems can also be used for drawers in tables or other extendable components from stationary structures.

By means of a guide system, a first assembly, connected to a cover element, can thus be moved relative to a second assembly, connected to a stationary structure, in order to at least partially expose or cover an opening in the stationary structure. It can also be provided that the guide system can move two assemblies in more than one movement direction. For example, it may be advantageous to use a guide system to move a window out of an opening in a wall and then to slide the window along the wall so that the opening is no longer covered but rather uncovered.

The problem with guide systems for the movable support of at least one cover element relative to a stationary structure is that the opening and/or closing can occur unintentionally, too easily and/or too quickly and/or too uncontrolled. For example, it is problematic if a cover element such as a window changes from a closed state to an open state on its own. Such an autonomous opening of a window can occur, for example, due to the influence of wind, which creates the risk of damage.

In another example, if a cover element is opened too easily, it can be problematic in that people, such as children, can accidentally or carelessly open it and fall from a stationary structure, posing a significant risk to life and limb.

### SUMMARY OF THE INVENTION

The object of the present invention is therefore to at least partially eliminate the disadvantages of the prior art and to provide an improved guide system in comparison with the prior art, which is distinguished in particular by an improved control over the covering and/or uncovering of an opening of a stationary structure by a cover element. The object is further to provide an arrangement with such an improved guide system and a method, which is improved compared to the prior art, for covering and opening at least one opening in a stationary structure by means of at least one cover element.

This object is achieved by a guide system for movably supporting at least one cover element for covering an opening in a stationary structure. The guide system has at least one first assembly for arrangement on the stationary structure and at least one second assembly for arrangement on at least one cover element. The guide system has a first guide device by which the two assemblies can be moved relative to one another in a first movement direction, and a second guide device by which the two assemblies can be moved relative to one another in a second movement direction, that is transverse, in particular orthogonal, to the first movement direction. At least one blocking device can be arranged in at least one blocking position in which a movement of the second assembly along the second movement direction can be braked and/or blocked, and in at least one release position in which a movement of the second assembly along the second movement direction is substantially unaffected by the at least one blocking device.

The at least one blocking device thus makes it possible to inhibit the movement of the at least one first assembly relative to the at least one second assembly, in other words to brake or block or both to brake and block the same.

This results in three advantageous cases:
1. Case: The blocking device can be used for braking.
2. Case: The blocking device can be used for blocking.
3. Case: The blocking device can be used for braking and blocking.

In order to explain the effect of the invention, an exemplary embodiment is used below in which the guide system is arranged with one assembly on a window and with another assembly on a wall. This embodiment is not intended to be limiting, but is intended only to clearly describe the advantages of the invention.

In the aforementioned embodiment, the window can be moved out of an opening in the wall or vice versa can be moved into the same, which corresponds to a movement along the first movement direction. If the window is then moved along the wall, the opening in the wall can be released, which corresponds to a movement along the second movement direction. Conversely, the window can be pushed back to at least partially cover the opening.

In the first case of the aforementioned embodiment, the blocking device can slow down a displacement of the window along the second movement direction. This is particularly advantageous if, for example, the window is open and a gust of wind moves the window along the second movement direction. Thus, a strong gust of wind could cause damage to the window, the guide system and/or the wall, but with the help of the blocking device, the movement can be slowed down, thus preventing damage to the parts. This can also provide additional protection for users who could injure themselves in such a case due to an uncontrolled moving window.

In the second case of the aforementioned exemplary embodiment, the blocking device ca block a displacement of the window along the second movement direction. This is especially beneficial when children are playing on a windowsill. It could happen that a child leans against the window and thus unintentionally moves the window along the wall in the second movement direction and releases the opening in the wall. In such a case, the child may fall out of the opening and seriously injure themselves. The blocking device can prevent such a movement of the window, since the blocking device must be deliberately brought into a release position before the window can be moved and thus the opening can be released.

In the third case of the aforementioned exemplary embodiment, the blocking device ca block and brake a displacement of the window along the second movement direction. This case combines the advantages of the first two cases and thus provides protection against damage to the components and protection for the users, in particular for child safety.

The term “blocking” in connection with a blocking device which can be arranged in at least one blocking position and/or one release position is understood here to mean braking, i.e. slowing down, and/or blocking a movement. A blocking device can therefore inhibit by deliberately slowing down the movement of one part relative to another, for example by frictional contact between the two parts. Instead of or in addition to braking, the blocking device can also inhibit by intentionally blocking the movement of one part relative to another part, in other words stopping or delaying it or preventing it from the outset, for example by means of a latch and a latch receiver which prevent at least one movement of the two parts relative to each other by means of contact.

In a preferred exemplary embodiment, the at least one blocking device or at least a part thereof is an integral component of the guide system, preferably of the second guide device and/or one of the two assemblies, and/or of a cover element and/or of a stationary structure.

According to a preferred embodiment variant of the guide system, the first guide device has at least one, preferably two, particularly preferably four, joint devices, by which the two assemblies can be brought into at least two joint end positions along the first movement direction. In a second joint end position, the two assemblies have a greater distance, preferably between 50 mm and 200 mm, particularly preferably between 100 mm and 150 mm, relative to one another than in a first joint end position. Preferably, the at least one joint device has at least one toggle lever with at least two straight and/or partially curved toggle lever arms, particularly preferably a toggle lever pair consisting of a support toggle lever with at least two support toggle lever arms and a drive toggle lever with at least two drive toggle lever arms.

The joint device can serve to move the second assembly away from the first assembly just far enough to enable movement along the second movement direction, in a specific exemplary embodiment along the stationary structure.

According to a preferred embodiment variant of the guide system, the at least one blocking element has at least one rotatably and/or displaceably mounted braking piece, preferably for a friction brake, an electric brake, a hydraulic and/or a magnetic brake, particularly preferably a brake block, a brake wedge, a brake comb and/or a brake pad. A movement of the second assembly along the second movement direction can be braked by the at least one braking piece in conjunction with the at least one counterpart, and/or has at least one rotatably and/or displaceably mounted blocking piece, preferably a bolt, and a movement of the second assembly along the second movement direction can be blocked by the at least one blocking piece in conjunction with the at least one counterpart.

According to a preferred embodiment variant of the guide system, the at least one counterpart has at least one braking counterpart, preferably for a friction brake, an electric brake, a hydraulic and/or a magnetic brake, particularly preferably with a brake pad. A movement of the second assembly along the second movement direction can be braked by the at least one braking counterpart in conjunction with the at least one blocking element, preferably a bolt receiver for a rotatably and/or displaceably mounted bolt, and a movement of the second assembly along the second movement direction can be blocked by the at least one blocking counterpart in conjunction with the at least one blocking element.

If the blocking device takes over the function of braking, a braking piece can be provided, wherein a braking piece, for example a brake block, can lead to braking through frictional contact with a braking counterpart, for example a brake strip with an integrated or separate brake pad.

A brake piece and/or a brake counterpart may have a brake pad, wherein a brake pad may be, for example, a powder coating, a roughened surface and/or a fabric band.

During braking, the braking piece can move relative to the braking counterpart or the braking counterpart can move relative to the braking piece or both the braking piece and the braking counterpart can move relative to each other during braking.

According to a preferred embodiment of the guide system, the at least one blocking element has at least one blocking piece and the at least one counterpart has at least one blocking counterpart, and the at least one blocking element and/or the at least one counterpart has a bevel, preferably a beveled surface. The at least one blocking element can pass the at least one counterpart unidirectionally through the at least one bevel during a movement of the two assemblies relative to one another along the second movement direction.

This can be particularly advantageous if, for example, for safety reasons, the assemblies are to be blocked in one direction along the second movement direction and are not to be blocked in the other direction along the second movement direction. In the aforementioned specific embodiment, in which a window can be moved along a wall by means of the guide system, the blocking device can thus block the movement of the window to release the opening in the wall for safety reasons and at the same time allow the opening in the wall to be covered without actuating the blocking device, specifically by at least one bevel and thereby enabling passage.

According to a preferred embodiment of the guide system, the at least one blocking device has at least one spring device, preferably a spiral spring, wherein the at least one spring device is connected to the at least one blocking element. Preferably, the at least one blocking element can be urged at least in regions into a recess of the at least one counterpart by a preloading spring force of the at least one spring device and/or the at least one blocking element can be displaced at least in regions out of a recess of the at least one counterpart against a preloading spring force of the at least one spring device, preferably by actuation of an actuator.

A spring device can offer the advantage that the blocking device is automatically moved into a locking position and/or a release position, thus increasing user-friendliness.

According to a preferred embodiment of the guide system, the at least one actuator has at least one lever arm, preferably a handle, for actuating the at least one blocking element. Preferably, the guide system has at least one cover element and the at least one actuator is arranged on the cover element and/or is foldable, particularly preferably foldable out of the cover element and/or foldable into the cover element, and the at least one first guide device has at least one joint device. The at least one actuator is at least partially concealed and/or inaccessible in the first joint end position and is at least partially visible and/or accessible in the second joint end position.

Folding and/or unfolding the actuator can be an additional safety feature to further increase control over the covering and/or exposure of the opening of the stationary structure.

According to a preferred embodiment variant of the guide system, at least one drive device is provided, by which at least one movement of the two assemblies relative to one another, preferably along the first movement direction and/or along the second movement direction, can be driven and/or the at least one blocking device can be driven from at least one blocking position into at least one release position and/or the at least one blocking device can be driven from at least one release position into at least one blocking position.

In a preferred embodiment of the guide system, the drive device can be operated manually and/or electrically.

In a preferred embodiment variant of the guide system, the drive device can be remotely controlled, and the drive device can be connected to a control unit by means of a physical line, in particular a cable, and/or wirelessly, in particular via a radio connection.

Furthermore, protection is sought for an arrangement with a guide system according to the invention, namely an arrangement comprising:
a stationary structure, in particular a wall element, with at least one opening,
at least one cover element with which the at least one opening can be covered at least in part, and
at least one guide system according to the invention, wherein the at least first assembly is arranged on the stationary structure and the at least one second assembly is arranged on the at least one cover element.

According to a preferred embodiment of the arrangement with the guide system:
the at least one actuator is arranged on the cover element, preferably on a side of the cover element facing the at least one opening of the stationary structure, and/or on the stationary structure, preferably on a side of the stationary structure facing the cover element, and/or
the at least one actuator can be folded out of the cover element and/or folded out of the stationary structure and/or can be actuated by folding out of the cover element and/or the stationary structure,
preferably the at least one actuator is at least partially concealed and/or inaccessible by at least a part of the arrangement in the closed position and is at least partially visible and/or accessible in the open position.

In a preferred embodiment variant of the arrangement, the actuation of the actuator moves the blocking device into the blocking position or release position when the actuator is folded out or folded in. However, only after the actuator has been unfolded is an actuation carried out, preferably by pulling a lever arm of the actuator, in order to move the blocking device into the blocking position or release position. The actuation of the actuator after folding out can be an additional safety feature to further increase control over the covering and/or exposure of the opening of the stationary structure.

Furthermore, protection is sought for a method, namely a method for covering and opening at least one opening in a stationary structure by means of at least one cover element, wherein the following method steps are provided:
the at least one cover element is moved between a closed position, in which the at least one cover element covers the at least one opening, and an open position, in which the cover element is spaced substantially orthogonally from the at least one opening, wherein the movement of the at least one cover element takes place in a first movement direction,
the at least one cover element is moved between the open position and a displacement position in which the at least one cover element is arranged laterally offset relative to the opening, wherein the movement of the at least one cover element takes place in a second movement direction transversely, in particular orthogonally, to the first movement direction, and
at least one blocking device is transferred from a blocking position, in which the at least one blocking device brakes and/or blocks a movement of the at least one cover element along the second movement direction, into at least one release position, in which a movement of the at least one cover element along the second movement direction is substantially unaffected by the at least one blocking device, and vice versa.

According to a preferred embodiment of the method with the guide system, at least one actuator is provided, by which the at least one blocking device is transferred from the blocking position into the release position. The at least one actuator is arranged concealed in the closed position and is released for actuation upon a movement of the at least one cover element from the closed position into the open position.

This can be particularly advantageous if the actuator should not be visible and/or accessible in the closed position for safety or design reasons.

In a preferred embodiment variant, the at least one blocking device can be moved from the at least one release position into at least one blocking position.

It should be noted at this point that the movement of the at least one blocking device can take place before, after and/or during a movement of the cover element, preferably between the closed position and the open position and/or between the open position and the displacement position.

It is conceivable, for example, to move the at least one cover element between the closed position and the open position in a first step, to move the blocking device from the blocking position to the release position in a second step and to move the at least one cover element between the open position and the displacement position in a third step.

It can be provided, for example, that in a first step the at least one cover element is moved between the closed position and the open position and in a second step, preferably simultaneously, both the blocking device is moved from the blocking position into the release position and the at least one cover element is moved between the open position and the displacement position.

### BRIEF DESCRIPTION OF THE DRAWINGS

Further details and advantages of the invention will be explained in more detail below with reference to the drawings, in which:

FIGS. 1 to 3 show different operating positions of an exemplary embodiment of a guide system with a stationary structure and a cover element or an arrangement;

FIG. 4 is a perspective view of an arrangement;

FIG. 5 is a perspective view of a stationary structure;

FIGS. 6 to 8 are various sectional views of an arrangement;

FIGS. 9 to 14 show different construction variants of a frame for a cover element;

FIGS. 15 and 16: show an exemplary embodiment of a guide system in a first joint end position;

FIGS. 17 and 18: show the exemplary embodiment of the guide system from FIGS. 15 and 16 in a second joint end position and/or a first rail end position;

FIGS. 19 and 20: show the exemplary embodiment of the guide system from FIGS. 15 and 16 in a second rail end position;

FIGS. 21 to 25: different perspective views of a joint device;

FIGS. 26 and 27: show an exemplary embodiment of an arrangement with the guide system from FIGS. 15 to 20 in the closed position;

FIGS. 28 and 29: show the exemplary embodiment of the arrangement from FIGS. 26 and 27 in the open position with a folded actuator;

FIGS. 30 and 31: show the exemplary embodiment of the arrangement from FIGS. 26 and 27 in the open position with an unfolded actuator;

FIGS. 32 to 37: show an exemplary embodiment of a blocking device;

FIGS. 38 to 54: show further schematic exemplary embodiments of blocking devices.

### DETAILED DESCRIPTION OF THE INVENTION

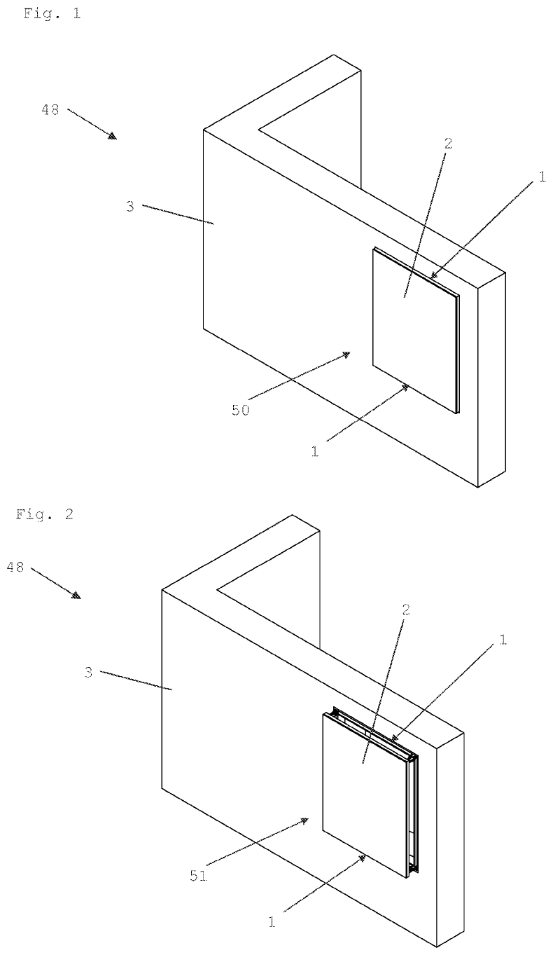

FIGS. 1 to 3 show different operating positions of an exemplary embodiment of a guide system 1 with a stationary structure 3 and a cover element 2 or an arrangement 48.

FIG. 1 shows the stationary structure 3, wherein the stationary structure 3 has an opening 49. The opening 49 is covered by the cover element 2, whereby the opening 49 of the stationary structure 3 is not visible in FIG. 1. The cover element 2 also conceals the guide system 1.

The guide system 1 can form the arrangement 48 together with the cover element 2 and the stationary structure 3.

The arrangement 48 is in the closed position 50, as shown in FIG. 1.

FIG. 2 shows the arrangement 48 from FIG. 1 in the open position 51.

FIG. 3 shows the arrangement 48 from FIG. 1 in the displacement position 52.

FIG. 3 shows a guide system 1, wherein the guide system 1 is provided for movably supporting at least one cover element 2 for covering an opening 49 in a stationary structure 3, wherein the guide system 1 has at least one first assembly 4 for arrangement on the stationary structure 3 and at least one second assembly 5 for arrangement on at least one cover element 2, wherein the guide system 1 has a first guide device 6, by means of which the two assemblies 4, 5 can be moved relative to one another in a first movement direction 7, and a second guide device 8, by means of which the two assemblies 4, 5 can be moved relative to one another in a second movement direction 9, that is transverse, in particular orthogonal, to the first movement direction 7, wherein at least one blocking device 10 is provided, wherein the at least one blocking device 10 can be arranged in at least one blocking position 11 in which a movement of the second assembly 5 along the second movement direction 9 can be braked and/or blocked, and in at least one release position 12 in which a movement of the second assembly 5 along the second movement direction 9 is substantially unaffected by the at least one blocking device 10.

In FIG. 3 an arrangement 48 is shown, wherein the arrangement 48 comprises:
a stationary structure 3, in particular a wall element, with at least one opening 49,
at least one cover element 2, with which the at least one opening 49 can be covered at least in part, and
at least one guide system 1 according to the invention, wherein the at least first assembly 4 is arranged on the stationary structure 3 and the at least one second assembly 5 is arranged on the at least one cover element 2.

As shown in FIGS. 1 to 3, according to a preferred embodiment of the arrangement 48, it can be provided that the first guide device 6 of the guide system 1 has at least one joint device 13 and the second guide device 8 of the guide system 1 has at least one guide rail 22, wherein
the cover element 2 is movable by means of the at least one joint device 13 from a closed position 50 into an open position 51, wherein in the closed position 50 the cover element 2 is arranged at least partially within the at least one opening 49 of the stationary structure 3 and in the open position 51 the cover element 2 is arranged outside the at least one opening 49 of the stationary structure 3, preferably in the open position 51 the cover element 2 is spaced substantially orthogonally from the at least one opening 49 of the stationary structure 3, and
the cover element 2 is movable by means of the at least one guide rail 22 from the open position 51 into a displacement position 52, wherein in the displacement position 52 the cover element 2 is arranged both outside the at least one opening 49 of the stationary structure 3, preferably substantially orthogonally spaced from the at least one opening 49 of the stationary structure 3, and is also displaced along the second movement direction 9 relative to the open position 51 and/or closed position 50.

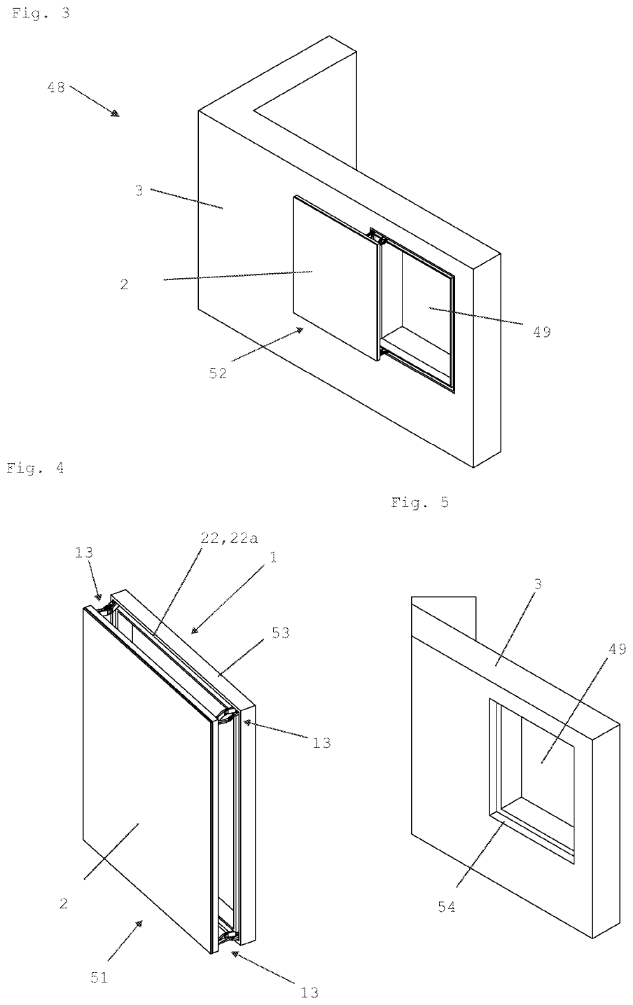

FIG. 4 shows a perspective view of an arrangement 48.

The arrangement 48 in FIG. 4 consists of the guide system 1, the frame 53 of the stationary structure 3 and the cover element 2.

The arrangement 48 in FIG. 4 is in the open position 51.

The joint device 13 of the guide system 1 is located in the second joint end position 14 in FIG. 4.

According to a preferred embodiment of the arrangement 48, it can be provided that the cover element 2 is a window, a panel and/or a door and, in a closed state, is arranged flush with the stationary structure 3 or partially protruding from the at least one opening 49 of the stationary structure 3.

FIG. 5 shows a perspective view of a stationary structure 3.

The stationary structure 3 may have an opening 49 into which the arrangement 48 from FIG. 4 can be arranged.

FIGS. 6 to 8 show various sectional views of an arrangement 48, which correspond to the embodiment of FIGS. 1 and 2.

FIG. 6 shows a sectional view of the arrangement 48, in which the arrangement 48 is in the open position 51 and the guide system 1 is in the second joint end position 14.

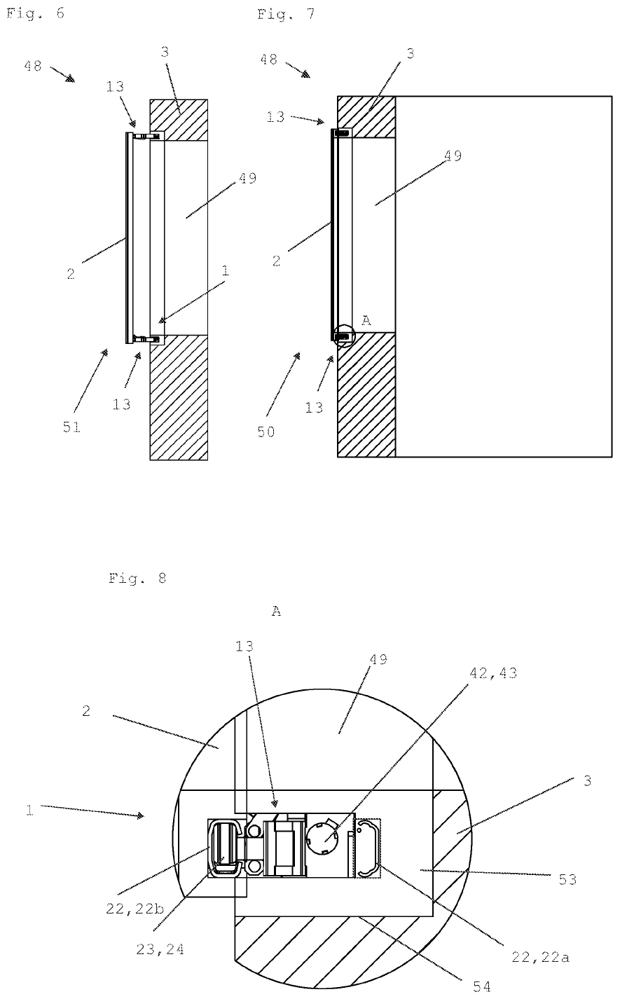

FIG. 7 shows a sectional view of the arrangement 48, in which the arrangement 48 is in the closed position 50 and the guide system 1 is in the first joint end position 15.

FIG. 8 shows the detailed view A of FIG. 7.

In the detailed view A of FIG. 8, the guide rail 22a is connected to the frame 53, which in turn is connected to the stationary structure 3 via the frame reveal 54.

In the detailed view of FIG. 8, the guide rail 22b is connected to the cover element 2.

In the detailed view of FIG. 8, the guide rails 22a and 22b are movable relative to each other.

In the closed position 50, the guide rails 22a and 22b can be arranged recessed in the cover element 2 and, preferably in the frame 53, in the stationary structure 3, in particular wherein the guide system 1 including the joint device 13 is substantially completely enclosed by the stationary structure 3 and/or the frame 53 and the cover element 2.

As in this exemplary embodiment, the first guide rails 22 can be substantially C-shaped and arranged parallel to one another.

In the detailed view A, a carriage 23 with rollers 24 is shown which is slidably mounted in the second guide rail 22b.

In FIG. 8, a part of the synchronization device 42, specifically the synchronization shaft 59, can be seen.

FIGS. 9 to 14 show different construction variants of a frame for a cover element 2.

The respective construction variants of the cover elements 2 comprise at least a front element 55, a profile 56, a seal 57 and a seal holder 58.

FIG. 9 shows a construction variant of the cover element 2, wherein the profile 56 is a wooden frame, the sealing holder 58 is an aluminum part and the front element 55 is a vacuum insulating glass.

FIG. 10 shows a construction variant of the cover element 2, wherein the profile 56 and the sealing holder 58 are an aluminum part and the front element 55 is a vacuum insulating glass.

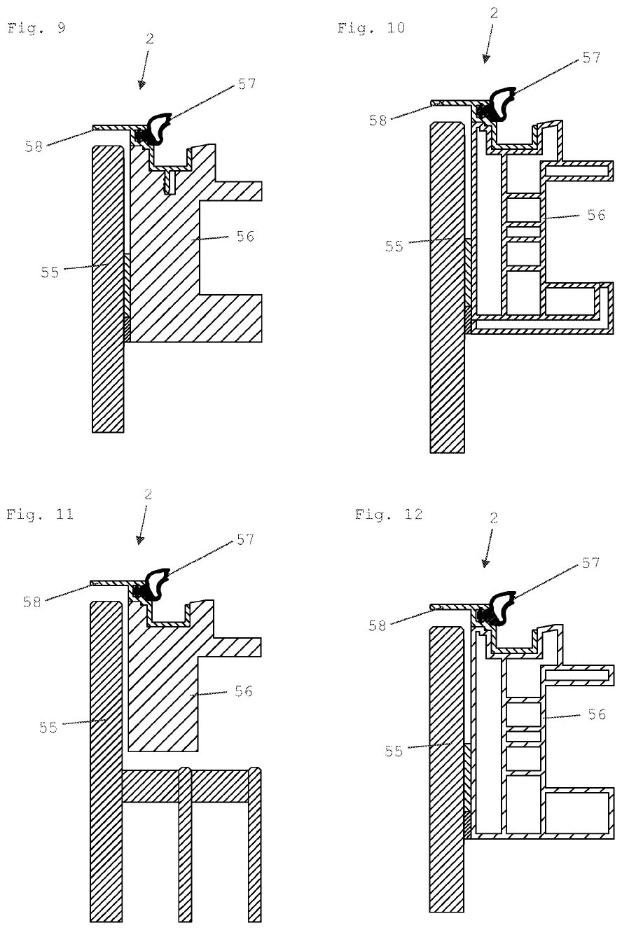

FIG. 11 shows a construction variant of the cover element 2, wherein the profile 56 is a wooden frame, the sealing holder 58 is an aluminum part and the front element 55 is a multi-pane insulating glass.

FIG. 12 shows a construction variant of the cover element 2, wherein the profile 56 is a plastic frame, the sealing holder 58 is an aluminum part and the front element 55 is a vacuum insulating glass.

FIG. 13 shows a construction variant of the cover element 2, wherein the profile 56 is a wooden frame, the sealing holder 58 is an aluminum part and the front element 55 is a multi-pane insulating glass.

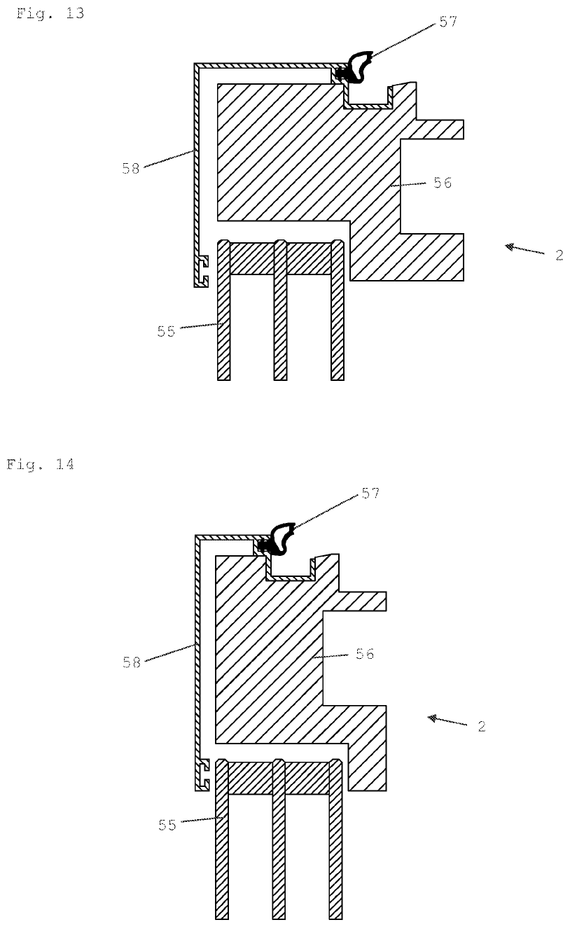

FIG. 14 shows a construction variant of the cover element 2, wherein the profile 56 is a wooden frame, the sealing holder 58 is an aluminum part and the front element 55 is a multi-pane insulating glass.

In principle, however, other design variants of such cover elements 2 are also conceivable.

FIGS. 15 and 16 show an exemplary embodiment of a guide system 1 in a first joint end position.

FIG. 15 shows a perspective view of the guide system 1 in a first joint end position.

The guide system 1 in FIG. 15 has the following components:
at least one first assembly 4, preferably comprising at least one fitting part for arrangement on a stationary structure 3,
at least one second assembly 5 preferably comprising at least one fitting part for arrangement on a cover element 2,
at least one first guide device 6, preferably comprising at least four joint devices 13, wherein the four joint devices 13 each connect two guide rails 22a with two guide rails 22b of the second guide device 8,
at least one second guide device 8, preferably comprising four guide rails 22, wherein two guide rails 22a can be connected to the stationary structure 3 via the at least one first assembly 4 and two guide rails 22b can be connected to the cover element 2 via the at least one second assembly 5.

FIG. 16 shows a detailed view B of a part of the guide system 1 from FIG. 15.

As shown in FIG. 15 and FIG. 16, the second assembly 5 can be arranged spatially close to the first assembly 4 along the first movement direction 7 via the first guide device 6, specifically the four joint devices 13 in FIG. 15. In FIGS. 15 and 16, the first guide device 6, specifically the four joint devices 13, is in a first joint end position 15, in which the two assemblies are less far apart from each other via retracted toggle levers 16 than in the second joint end position 14.

The joint device 13 in FIG. 16 is located in the first joint end position 15 and can be moved by a drive roller 44 along the first movement direction 7 into the joint end position 14 and then moved back again along the first movement direction 7 into the first joint end position 15.

By the movements of the first guide device 6 along the first movement direction 7, preferably between the first joint end position 15 and the second joint end position 14, the first assembly 4 and the second assembly 5 can be moved away from each other or towards each other.

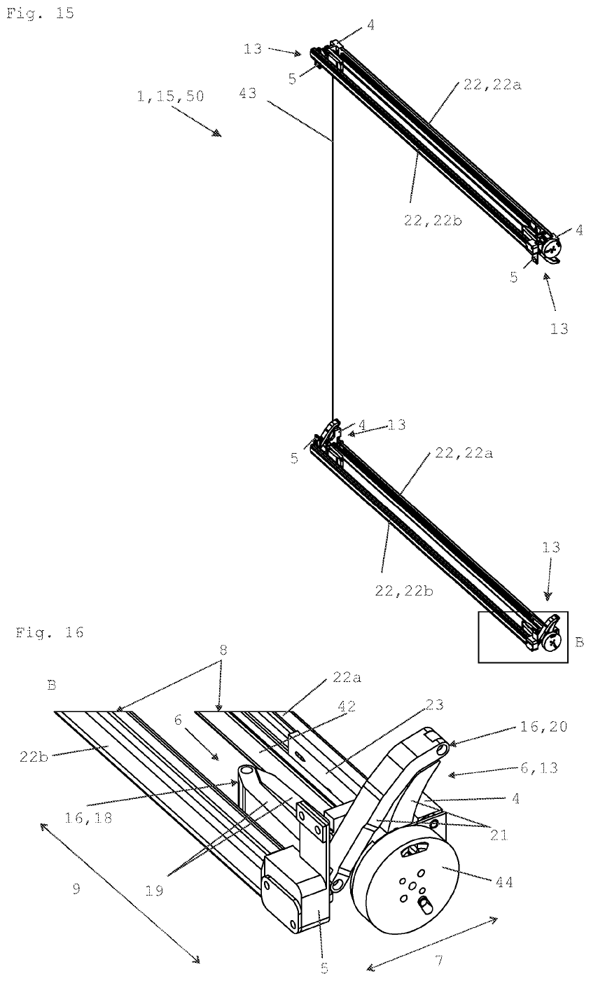

FIGS. 17 and 18 show the exemplary embodiment of the guide system from FIGS. 15 and 16 in a second joint end position and/or a first rail end position.

FIG. 17 shows a perspective view of the guide system 1 from FIGS. 15 and 16 in the second joint end position 14.

As already explained in FIGS. 15 and 16, the two assemblies 4, 5 can be located at a greater distance from each other than in the first joint end position 15.

As shown in FIG. 17, the guide system 1 is simultaneously in the second joint end position 14 and in the first rail end position 25.

FIG. 18 shows a detailed view C of a part of the guide system 1 from FIG. 17.

As shown in FIG. 18, the joint device 13 is in the second joint end position 14, in which the knee levers 16 of the joint device 13 are in a substantially fully extended position.

According to a preferred embodiment of the guide system 1, it can be provided that the second guide device 8 has at least one guide rail 22 and at least one carriage 23, preferably with at least one roller 24, by means of which the two assemblies 4, 5 can be brought into at least two rail end positions 25, 26 along the second movement direction 9, wherein in a first rail end position 25 the two assemblies 4, 5 are arranged substantially in alignment in the direction of view of the first movement direction 7 and in a second rail end position 26 the two assemblies 4, 5 are arranged offset relative to one another in the direction of view of the first movement direction 7, preferably wherein the first assembly 4 has a first guide rail 22a, the second assembly 5 has a second guide rail 22b, a part of the first guide device 6 is displaceably mounted in and/or on the first guide rail 22a and a further part of the first guide device 6 is displaceably mounted in and/or on the second guide rail 22b.

FIGS. 19 and 20 show the exemplary embodiment of the guide system 1 from FIGS. 15 and 16 in a second rail end position.

FIG. 19 shows a perspective view of the guide system 1 from FIGS. 15 and 16 in the second rail end position 26.

In FIG. 19, the two assemblies 4, 5 are not only spatially further apart from each other along the first movement direction 7, but are additionally displaced relative to each other along the second movement direction 9 by the second guide device 8.

The displacement of the assemblies 4, 5 along the second movement direction 9 can be realized by the second guide device 8.

As shown in FIGS. 15 and 19, the second guide device 8 may have four guide rails 22, wherein two of the guide rails 22a are connected to the first assembly 4 and the other two guide rails 22b are connected to the second assembly 5.

As shown in FIGS. 15 and 19, a guide rail 22a is respectively connected to another guide rail 22b via the first guide device 6, specifically via two joint devices 13.

FIG. 20 shows a detailed view D of a part of the guide system 1 from FIG. 19.

In order to realize a displacement of the assemblies 4, 5 by the second guide device 8 along the second movement direction 9, the joint devices 13 in FIG. 20 are connected to the guide rails 22 via a non-displaceable support and/or via a displaceable support, preferably a carriage 23 with rollers 24.

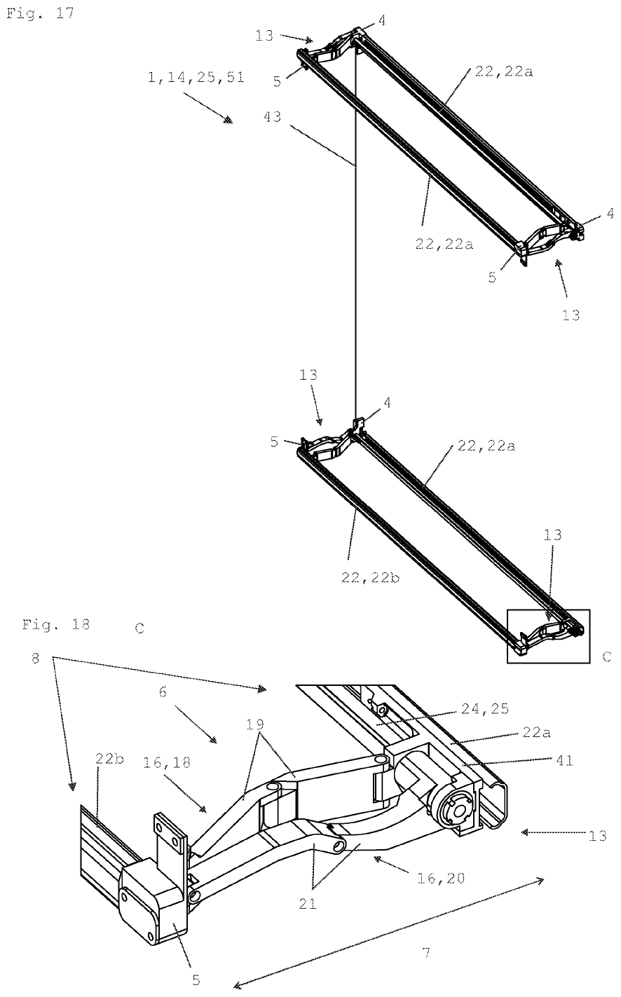

FIGS. 21 to 25 show different perspective views of a joint device 13.

According to a preferred embodiment of the guide system 1, it can be provided that the first guide device 6 has at least one, preferably two, particularly preferably four, joint devices 13, by means of which the two assemblies 4, 5 can be brought into at least two joint end positions 14, 15 along the first movement direction 7, wherein in a second joint end position 14 the two assemblies 4, 5 have a greater distance, preferably between 50 mm and 200 mm, particularly preferably between 100 mm and 150 mm, relative to one another than in a first joint end position 15, preferably wherein the at least one joint device 13 has at least one toggle lever 16 with at least two straight and/or partially curved toggle lever arms 17, particularly preferably a toggle lever pair consisting of a support toggle lever 18 with at least two support toggle lever arms 19 and a drive toggle lever 20 with at least two drive toggle lever arms 21.

FIG. 21 shows a joint device 13 in the joint end position 15.

FIG. 22 shows the joint device 13 from FIG. 21 in a position between the first joint end position 15 and the second joint end position 14.

FIG. 23 shows the joint device 13 from FIGS. 21 and 22 in the second joint end position 14.

The joint device 13 from FIGS. 21, 22 and 23 comprises the following components:
a first toggle lever 16 with two toggle lever arms 17, specifically a supporting toggle lever 18 with two supporting toggle lever arms 19,
a second toggle lever 16 with two toggle lever arms 17, specifically a drive toggle lever 20 with two drive toggle lever arms 21,
connecting elements via which the respective toggle lever arms 17 are pivotally connected to one another via joint axes 61 or via which the respective toggle lever arms 17 are connected to other parts, preferably the assemblies 4 or 5 or the carriage 23.

Due to the sum of the pivotable joint axes 61 of the joint device 13, the joint device 13 can be moved along the first movement direction 7 between two joint end positions 14, 15.

By connecting the joint device 13 to the carriage 23, which has three rollers 24 as shown in FIG. 23, one of the guide rails 22 of the second guide device 8 can be moved along the second movement direction 9 relative to another guide rail 22.

The movement of a guide rail 22 relative to another guide rail 22 of the second guide device 8 along the second movement direction 9 can, as shown in FIGS. 22 to 24, be independent of the position of the first guide device 6, specifically independent of the joint end position 14, 15 of the joint device 13.

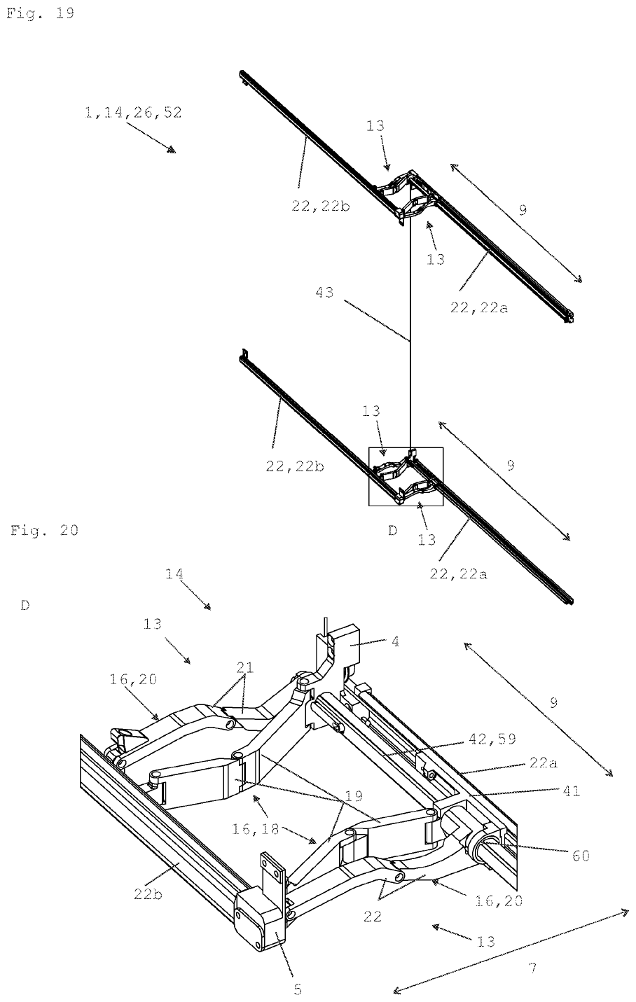

FIG. 24 shows an exploded view of the joint device 13 from FIGS. 21 to 23.

The carriage 23 carries three rollers 24. The joint device 13 can be mounted on and/or in one of the guide rails 22, preferably displaceably, via the carriage 23.

The joint device 13 has, as described in FIG. 23, two pairs of toggle levers, specifically a support toggle lever 18 and a drive toggle lever 20.

FIG. 25 shows a section of a guide system 1, wherein the first assembly 4 is connected to a frame 53 of a stationary structure 3 and via a joint device 13 to the second assembly 5.

In FIG. 25, a part of a synchronization device 42 can be seen, specifically a synchronization cable 45, which is deflected via a deflection pulley in the assembly 5.

FIGS. 26 and 27 show an exemplary embodiment of an arrangement 48 with the guide system 1 from FIGS. 15 to 20 in the closed position 50.

FIG. 26 shows an arrangement 48, wherein the guide system 1 is not visible since the arrangement 48 is in the closed position 50.

The following components can be arranged on the frame 53 of the stationary structure 3, as shown in FIG. 26:
at least two drive devices 39 arranged at opposite corners of the frame 53 of the stationary structure 3,
at least one drive roller 44, wherein a drive roller 44 can be seen at the upper right corner of the frame 53,
at least one synchronization device 42, preferably comprising a cable pull 43 made of an eight-shaped synchronization cable 45,
at least one compensation device 46, preferably comprising a compensation pulley 62 and a compensation cable 47.

According to a preferred embodiment of the guide system 1, it can be provided that at least one drive device 39 is provided, by means of which at least one movement of the two assemblies 4, 5 relative to one another, preferably along the first movement direction 7 and/or along the second movement direction 9, can be driven and/or the at least one blocking device 10 can be driven from at least one blocking position 11 into at least one release position 12 and/or the at least one blocking device 10 can be driven from at least one release position 12 into at least one blocking position 11.

The synchronization device 42 can serve to connect the drive device 39 to at least one drive roller 44 and thus to enable a synchronized movement by means of at least one guide device 6, 8 of the cover element 2 in at least one movement direction 7, 9.

According to a preferred embodiment of the guide system 1, it can be provided that the first assembly 4 has at least two, preferably four, first sub-assemblies 40 and the second assembly 5 has at least two, preferably four, second sub-assemblies 41, and the guide system 1 has at least one synchronization device 42 for synchronizing a movement of the sub-assemblies 40, 41, preferably wherein the at least one synchronization device 42 has at least one synchronization shaft and/or at least one cable 43, preferably wherein the cable 43 comprises at least two drive rollers 44 and at least one synchronization cable 45 arranged between the drive rollers 44, preferably running in the shape of a figure eight.

The compensation device 46 can serve to prevent tilting of the cover element 2 as a result of movement along the second movement direction 9. This is particularly useful if the cover element is no longer supported at all four corners, but at least part of the cover element 2 is free-standing without support. In such a case, the cover element 2 may be moved in an undesirable manner by gravity.

According to a preferred embodiment of the guide system 1, a guide system 1 can be provided, comprising:
at least two guide rails 22 which are connected to the at least one first assembly 4,
at least one first guide body which is slidably arranged in one of the two guide rails 22,
at least one second guide body which is slidably arranged in the other of the two guide rails 22, and
a compensation device 46 for compensating a tilting moment of a cover element 2
wherein the cover element 2 is movable by the guide system 1 between a first position, preferably an open position 51, and a second position, preferably a displacement position 52, wherein the compensation device 46 has at least one compensation cable 47, wherein the at least one compensation cable 47 connects the first guide body and the second guide body to one another, and wherein a deflection device is provided, by means of which the at least one compensation cable 47 can be guided orthogonally to the second movement direction 9, at least in some regions, preferably in a region between the at least two guide rails 22.

FIG. 27 shows a detailed view E from FIG. 26. A flush transition can be seen between the frame 53 of the stationary structure 3 and the cover element 2, so that the guide system 1 is completely covered by the stationary structure 3 and/or by the cover element 2.

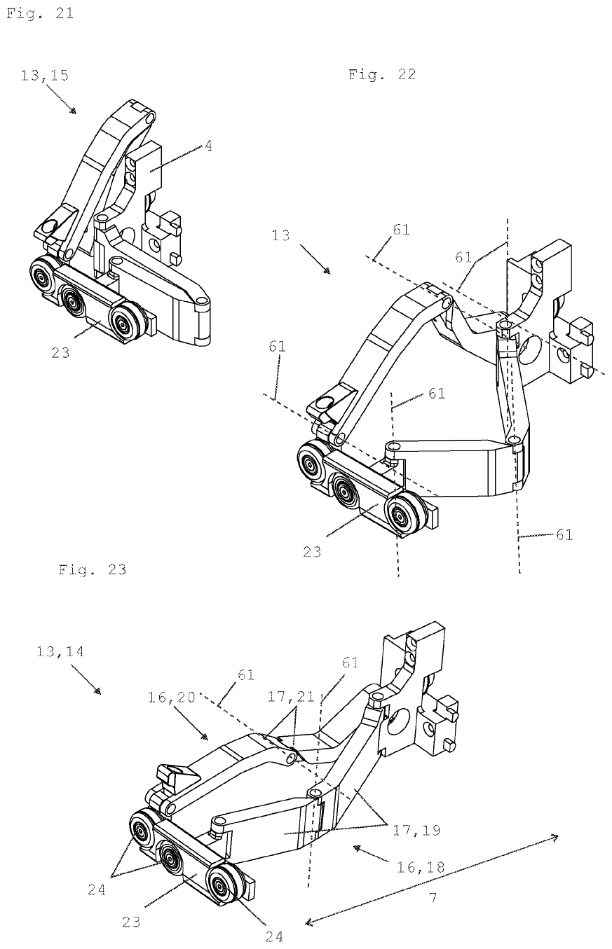

FIGS. 28 and 29 show the exemplary embodiment of the arrangement from FIGS. 26 and 27 in the open position 51 with a folded actuator 37.

FIG. 28 shows the arrangement 48 from FIGS. 26 and 27, wherein the arrangement 48, triggered by the first guide device 6, is no longer in the closed position 50 but in the open position 51.

In the open position 51 of the arrangement 48, as shown in FIG. 28, in contrast to FIGS. 26 and 27, the actuator 37 of the blocking device 10 can be visible and/or accessible.

FIG. 29 shows a detailed view F from FIG. 28.

In the open position 51 of FIG. 28, in addition to the actuator 37, a part of the guide system 1 can also be seen. The actuator 37 is located in the cover element 2 and in a folded position so that the actuator 37, specifically the lever arm of the actuator 37, is flush with the surface of the cover element 2. A part of the second guide device 8, specifically a joint device 13, is located in the second joint end position 14.

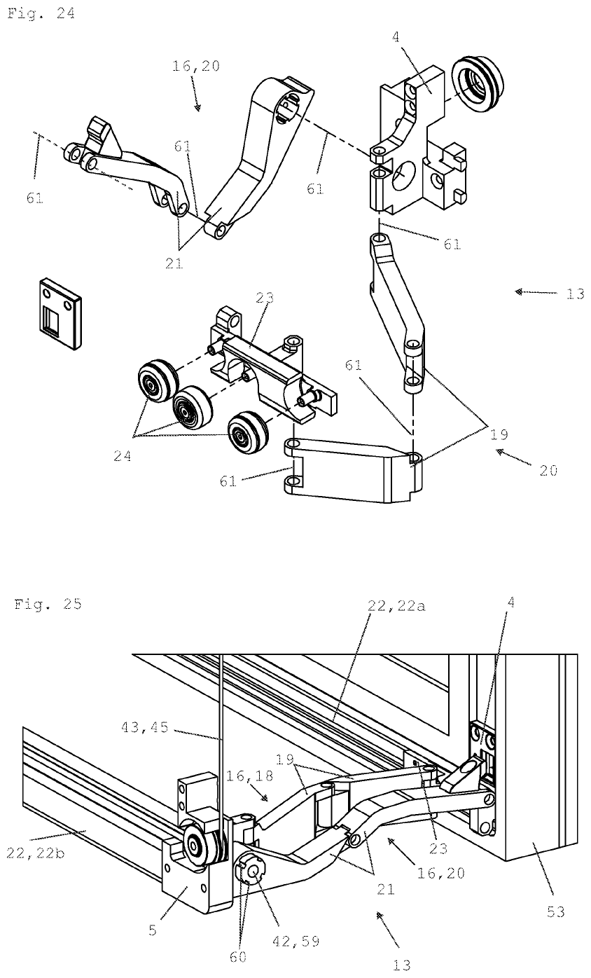

FIGS. 30 and 31 show the exemplary embodiment of the arrangement from FIGS. 26 and 27 in the open position 51 with a unfolded actuator 37.

In contrast to FIGS. 26 to 29, the actuator 37 in FIG. 30 is in an unfolded state.

FIG. 31 shows a detailed view G from FIG. 30.

In FIG. 31 it can be seen that the actuator 37 is no longer flush with the surface of the cover element 2, but in its unfolded state protrudes with its lever arm from an opening of the cover element 2.

In a preferred embodiment, it can be provided that the actuator 37 can be folded out by pressing one of its ends, preferably an end of the actuator 37 opposite the lever arm.

In a preferred embodiment, it can be provided that the actuator 37 actuates the blocking device 10 by unfolding the lever arm, in other words the blocking device 10 is brought into a blocking position 11 and/or the blocking device 10 is brought into a release position 12.

In a preferred embodiment, it can be provided that the actuator 37 does not actuate the blocking device 10 by unfolding the lever arm, but rather the blocking device 10 is only actuated by additionally tightening the lever arm of the actuator 37, in other words the blocking device 10 is brought into a blocking position 11 and/or the blocking device 10 is brought into a release position 12.

According to a preferred embodiment of the arrangement 48, it can be provided that
wherein the at least one actuator 37 is arranged on the cover element 2, preferably on a side of the cover element 2 facing the at least one opening 49 of the stationary structure 3, and/or on the stationary structure 3, preferably on a side of the stationary structure 3 facing the cover element 2, and/or
wherein the at least one actuator 37 can be folded out of the cover element 2 and/or folded out of the stationary structure 3 and/or can be actuated by folding out of the cover element and/or the stationary structure 3,
preferably wherein the arrangement 48 is designed according to claim 18 or 19 and the at least one actuator 37 is at least partially concealed and/or inaccessible by at least a part of the arrangement 48 in the closed position 50 and is at least partially visible and/or accessible in the open position 51.

FIGS. 32 to 37 show an exemplary embodiment of a blocking device 10.

FIG. 32 shows a perspective view of a guide system 1, a cover element 2 and a blocking device 10.

FIG. 33 shows a detailed view H in which a part of the guide system 1, the cover element 2 and the blocking device 10 from FIG. 32 can be seen.

A blocking device 10 may comprise the following components:
at least one blocking element 27,
at least one counterpart 28,
at least one spring device 36,
at least one mediator 38,
at least one actuator 37.

In FIG. 33 it can be seen that a mediator 38, specifically a cable, runs along the first movement direction 7. The mediator 38 extends to a blocking element 27.

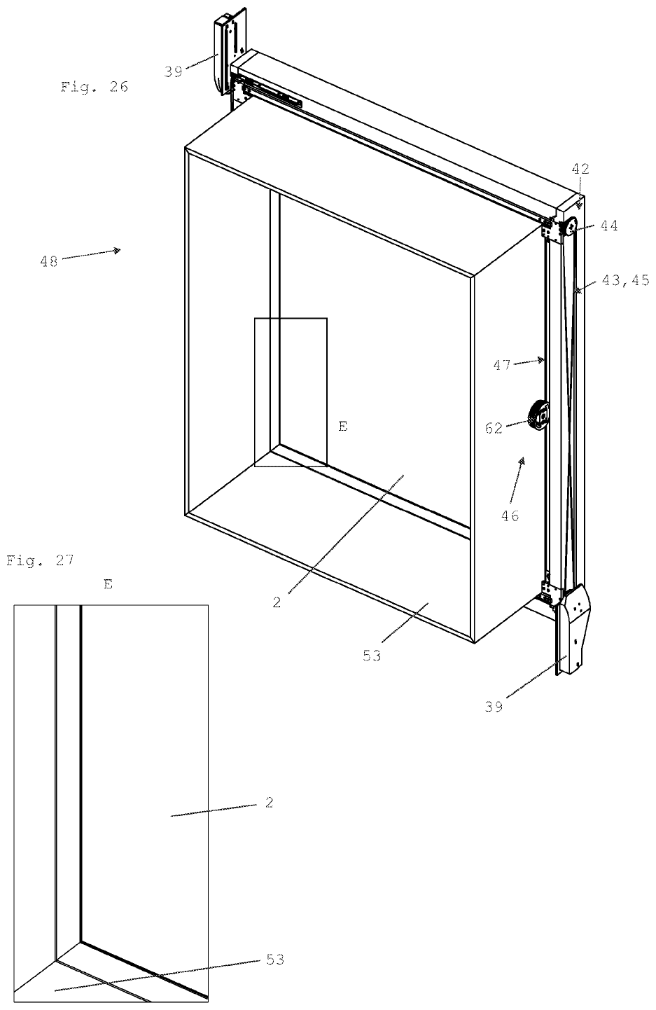

FIG. 34 shows a detailed view I of a part of the blocking device 10 from FIG. 33.

As shown in FIG. 34, the blocking device 10 may comprise a mediator 38, a blocking element 27, a counterpart 28, a spring device 36.

As shown in FIG. 34, the blocking element 27 can be connected via the spring device 36 to a part of the first guide device 6 and/or the second guide device 8, specifically to a carriage 23, which is displaceable along the second movement direction 9. This makes it possible to move the cover element 2 along the second movement direction 9 when the blocking device 10 is in a release position 12.

The pre-loaded spring force of the spring device 36 can displace the blocking element 27, as shown in FIG. 34, in a receiver region 34 of the counterpart 28. In this blocking position 11, the blocking element 27 comes into contact with the boundary 35 of the receiver region 34 of the counterpart 28 as soon as the cover element is displaced along the second movement direction 9, specifically from the open position 51. The blocking position 11 shown in FIG. 34 thus blocks the lateral displacement of the cover element 2.

As indicated in FIGS. 32 to 34, by actuating the actuator 37, the action mediator 38 can pull the blocking element 27 along the first movement direction 7 in the direction of the cover element 2 against the preloaded spring force of the spring device 36. In this way, the blocking element 27 moves out of the receiving region 34 of the counterpart 28, whereby the cover element 2 can be moved along the second movement direction 9 without the blocking element 27 coming into contact with the boundary 35 of the receiving region 34 of the counterpart 28 and thus blocking the movement along the second movement direction 9 of the cover element.

By retracting the locking element 27 against the pre-loaded spring force of the spring device 36 by actuating the actuator 37, specifically indirectly via the pull of the mediator 38, the locking element 27 of the blocking device 10 can move from a blocking position 11 into a release position 12.

According to a preferred embodiment of the guide system 1, it can be provided that the at least one blocking device 10 has at least one blocking element 27 and at least one counterpart 28, wherein the at least one blocking element 27 is at least partially in contact with the at least one counterpart 28 in the at least one blocking position 11 and is arranged at a distance from the at least one counterpart 28 in the at least one release position 12.

According to a preferred embodiment of the guide system, it can be provided that the at least one blocking element 27 is rotatably and/or displaceably mounted in a part, preferably a carriage 23, of the first or second guide device 6, 8 and the at least one counterpart 28 is mounted in a part of the first assembly 4 or in a part of the second assembly 5 or the at least one counterpart 28 is itself a part of the first assembly 4 or the second assembly 5.

According to a preferred embodiment of the guide system 1, it can be provided that the at least one counterpart 28 has at least one receiver region 34, preferably with a substantially round and/or angular cross-section, with a boundary 35, preferably wherein the receiver region 34 is an imaginary volume of a recess in the at least one counterpart 28, wherein the at least one blocking element 27 contacts the boundary 35 at least in some regions in at least one blocking position 11.

According to a preferred embodiment of the guide system 1, it may be provided that the at least one blocking device 10 has at least one spring device 36, preferably a coil spring, wherein the at least one spring device 36 is connected to the at least one blocking element 27, preferably wherein the at least one blocking element 27 can be pushed at least partially into a recess of the at least one counterpart 28 by a preloaded spring force of the at least one spring device 36 and/or the at least one blocking element 27 can be displaced at least in regions out of a recess in the at least one counterpart 28 against a preloaded spring force of the at least one spring device 36, preferably by means of actuation of an actuator 37.

A method can be implemented with a guide system 1, namely a method for covering and opening at least one opening 49 in a stationary structure 3 by means of at least one cover element 2, implemented by the following method steps:
the at least one cover element 2 is moved between a closed position 50, in which the at least one cover element 2 covers the at least one opening 49, and an open position 51, in which the cover element 2 is spaced substantially orthogonally from the at least one opening 49, wherein the movement of the at least one cover element 2 takes place in a first movement direction 7,
the at least one cover element 2 is moved between the open position 51 and a displacement position 52, in which the at least one cover element 2 is arranged laterally offset relative to the opening 49, wherein the movement of the at least one cover element 2 takes place in a second movement direction 9 transverse, in particular orthogonal, to the first movement direction 7, and
at least one blocking device 10 is moved from a blocking position 11, in which the at least one blocking device 10 brakes and/or blocks movement of the at least one cover element 2 along the second movement direction 9, to at least one release position 12, in which movement of the at least one cover element 2 along the second movement direction 9 is substantially unaffected by the at least one blocking device 10, and vice versa.

According to a preferred embodiment of the method, it can be provided that the at least one blocking device 10 must be moved from the blocking position 11 into the at least one release position 12 before a movement of the at least one cover element 2 along the second movement direction 9 starting from the open position 51 in the direction of the displacement position 52 is possible.

FIGS. 35 to 37 show perspective views of the blocking device 10 from FIGS. 32 to 34, wherein the cover element 2 is hidden and the blocking device 10 is in a release position 12.

FIG. 35 shows the entire blocking device 10, wherein the blocking device 10 is in a release position 12 by actuating the actuator 37.

FIG. 36 shows a detailed view J of the blocking device 10 from FIG. 35.

Due to the hidden cover element 2, it can be seen in FIG. 36 how the mediator 38 is deflected via a part of the second assembly 5, which is connected to the cover element 2.

FIG. 37 shows a detailed view K of the blocking device 10 from FIG. 36.

In contrast to FIGS. 32 to 34, which show the blocking device 10 in a blocking position 11, FIGS. 35 to 37 show the blocking device 10 in the release position 12.

As shown in FIG. 37, in the release position 12 the blocking element 27 is not located within the receiver area 34 of the counterpart 28 but outside the receiver area 34. By actuating the actuator 37 and consequently by tightening the mediator 38, the blocking element 27 can be moved against the prestressed spring force of the spring device 36 along the first movement direction 7 in the direction of the cover element 2.

By actuating the actuator 37 and thus moving the blocking device 10 into the release position 12, the two assemblies 4, 5 can be moved relative to each other and/or the cover element 2 relative to the stationary structure along the second movement direction 9.

According to a preferred embodiment of the guide system 1, it can be provided that the at least one blocking device 10 has at least one actuator 37, wherein the at least one blocking device 10 can be brought into the at least one blocking position 11 and/or into the at least one release position 12 by means of the at least one actuator 37, preferably wherein the at least one actuator 37 is connected to the at least one blocking element 27 and/or to the at least one counterpart 28 directly and/or indirectly via a mediator 38, by means of which tensile forces and/or compressive forces can be transmitted, particularly preferably wherein the mediator 38 is a cable.

According to a preferred embodiment of the guide system 1, it may be provided that the at least one actuator 37 has at least one lever arm, preferably a handle, for actuating the at least one blocking element 27, preferably wherein the guide system 1 has at least one cover element 2 and the at least one actuator 37 is arranged on the cover element 2 and/or is foldable, particularly preferably unfoldable out of the cover element 2 and/or foldable into the cover element 2, wherein the at least one first guide device 6 has at least one joint device 13 according to claim 2, wherein the at least one actuator 37 is at least partially concealed and/or inaccessible in the first joint end position 15 and is at least partially visible and/or accessible in the second joint end position 14.

According to a preferred embodiment of the method, it may be provided that at least one actuator 37 is provided, by means of which the at least one blocking device 10 is moved from the blocking position 11 into the release position 12, wherein the at least one actuator 37 is arranged concealed in the closed position 50 and is released for actuation when the at least one cover element 2 moves from the closed position 50 into the open position 51.

According to a preferred embodiment of the method, it can be provided that the method is carried out with the aid of at least one guide system 1 according to the invention or in at least one arrangement according to the invention.

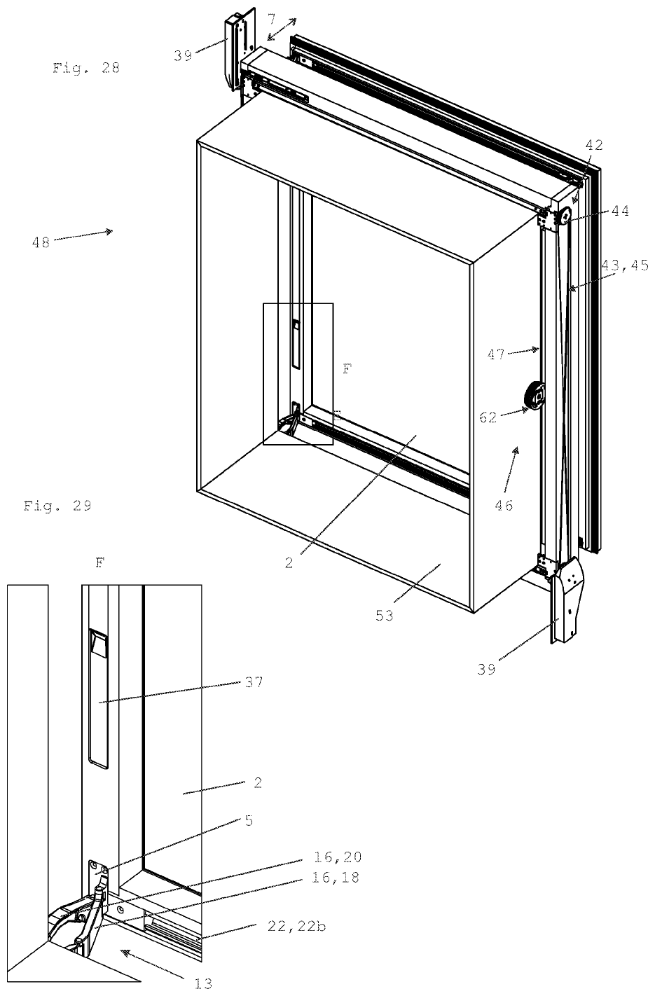

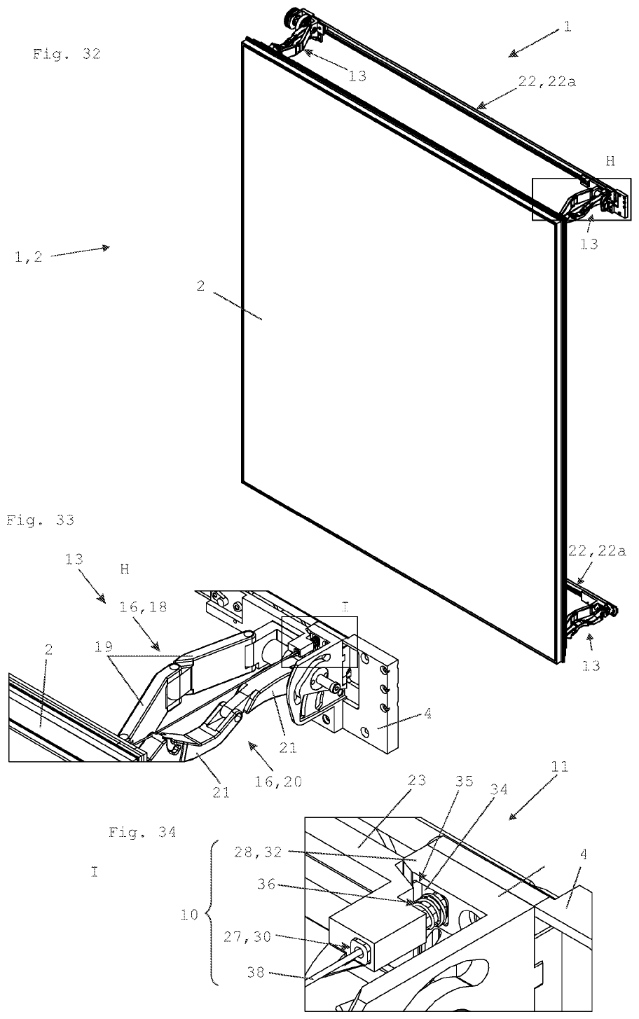

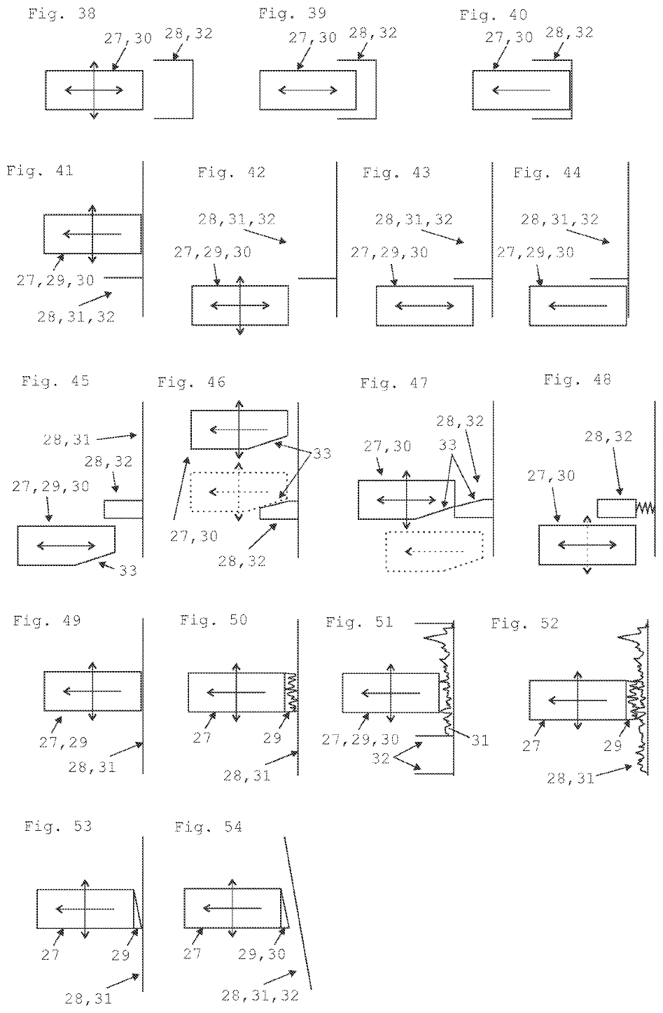

FIGS. 38 to 54 show further schematic embodiments of blocking devices 10, wherein in each case only the at least one blocking element 27 and the at least one counterpart 28 are shown.

For all subsequent figures, a blocking element 27 can be a braking piece 29 for braking a movement of an assembly 4,5 along a movement direction 7,9 and/or a blocking piece 30 for blocking a movement of an assembly 4,5 along a movement direction 7,9. The blocking element 27 can therefore fulfill either one of the two functions of braking and blocking or both functions together. Depending on the functional scope of the blocking element 27, a corresponding counterpart 28 is necessary, analogously a braking counterpart 31 and/or a blocking counterpart 32.

Blocking can be realized as shown in FIGS. 32 to 37.

Braking can be achieved, for example, by the braking element 27 being moved along one of the directions of movement 7, 9, but being impaired by a brake pad on one of the guide rails 22 which is in contact with the blocking element 27. In such an example, the brake pad represents the brake counterpart 31.

Furthermore, for all schematic exemplary embodiments of blocking devices 10 in FIGS. 38 to 54, blocking elements 27 can be moved from at least one blocking position 10 into at least one release position 12 or vice versa, preferably along the first movement direction 7 starting from FIGS. 32 to 37. In addition, it is also possible for the blocking element 27 to be moved from a specific blocking position 11 to another blocking position 11 or from a specific release position 12 to another release position 12. The movement possibilities of the blocking element 27 in FIGS. 38 to 54 are shown by arrows.

The illustrated exemplary embodiments of blocking devices are not to be understood as limiting. Combinations of the mechanisms described or other blocking mechanisms are conceivable.

FIGS. 38, 39 and 40 show a blocking element 27 in a blocking position 11 in FIG. 40, in which a blocking between the blocking element 27 and the counterpart 28 is realized, in a release position 12 in FIG. 38 and in a position in between in FIG. 39, which also corresponds to a blocking position 11.

In the case of FIGS. 38, 39 and 40, the blocking element 27 is only a blocking element 30.

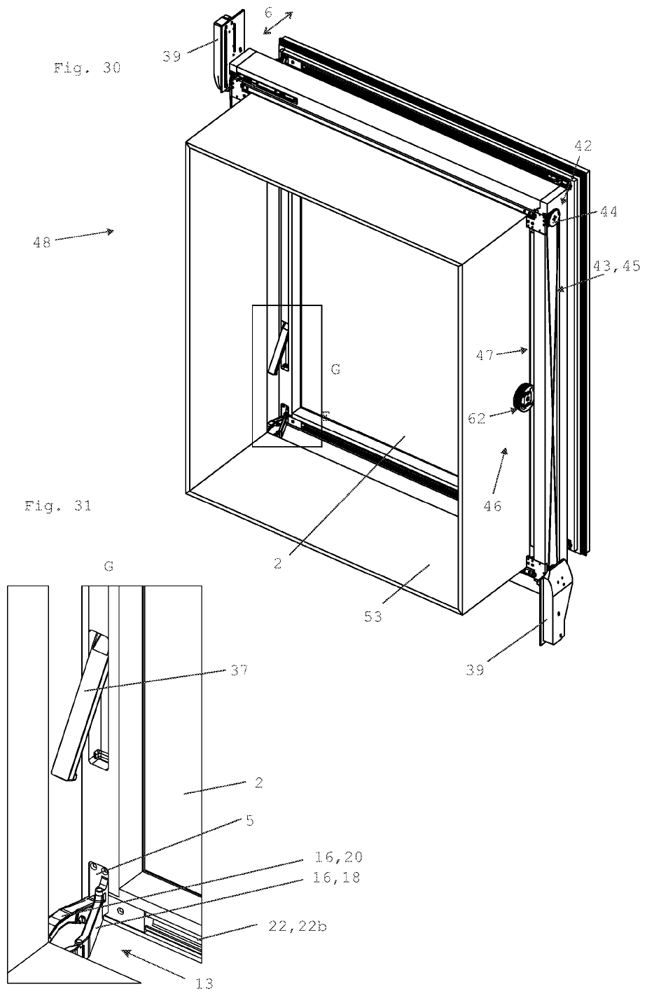

FIGS. 41, 42, 43 and 44 show a blocking element 27 in a blocking position 11, in which braking is realized by sliding contact between the locking element 27 and the counterpart 28, and the same blocking element 27 in positions analogous to FIGS. 38 to 40, in which blocking and releasing of the locking element 27 is realized.

In the case of FIGS. 41, 42, 43 and 44, the blocking element 27 is simultaneously a braking element 29 and a blocking element 30.

FIG. 45 shows a schematic exemplary embodiment of a blocking element 27 which has a bevel 33.

FIGS. 46 and 47 show a schematic exemplary embodiment of a blocking element 27 and a counterpart 28, both of which have a bevel 33. The dashed positions show that the locking element 27 overruns the counterpart 28.

The blocking element 27 can move towards the counterpart 28, as shown in FIG. 46. As soon as the blocking element 27 contacts the bevel 33 of the counterpart 28 with its own corresponding bevel 33, the current position is left in the course of the movement of the blocking element 27. This movement is continued by the bevels 33, as shown in FIG. 47, until the blocking element is in a release position 12, in which the counterpart 28 can be overrun by the blocking element 27. After passing over, the blocking element 27 can be moved again from the release position 12 into a blocking position 11.

In a preferred embodiment, it can be provided that the blocking element 27 and/or the counterpart 28 has at least one bevel 33.

The number of bevels 33 is not limited to the embodiments shown.

The shape of the bevels 33 is not limited to the embodiments shown; for example, the bevel 33 may be substantially straight and/or have curved regions.

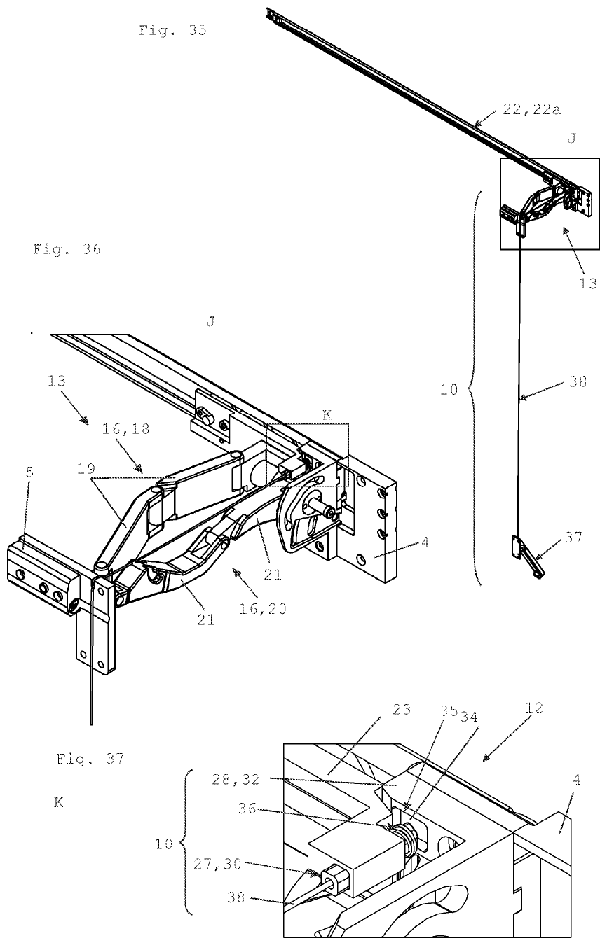

In FIG. 48, a further schematic exemplary embodiment can be seen in which a movement over a spring-loaded counterpart 28 is made possible by the blocking element 27.

FIG. 49 shows a blocking element 27 and a counterpart 28, which only realize braking. This means that there is a brake piece 29 and a brake counterpart 31.

FIGS. 50, 51 and 52 show schematic exemplary embodiments in which at least the blocking element 27 and/or the counterpart 28 have a brake pad.

FIGS. 53 and 54 show schematic exemplary embodiments in which the blocking element 27 has a brake wedge which is blocked on a straight or inclined plane.

According to a preferred embodiment of the guide system, it may be provided that the at least one blocking element 27 has at least one rotatably and/or slidably mounted brake piece 29, preferably for a friction brake, an electric brake, a hydraulic and/or a magnetic brake, particularly preferably a brake block, a brake wedge, a brake comb and/or a brake pad, wherein movement of the second assembly 5 along the second movement direction 9 can be braked by the at least one brake piece 29 in conjunction with the at least one counterpart 28, and/or at least one rotatably and/or slidably mounted blocking piece 30, preferably a bolt, wherein movement of the second assembly 5 along the second movement direction 9 can be blocked by the at least one blocking piece 30 in conjunction with the at least one counterpart 28.

According to a preferred embodiment of the guide system 1, it may be provided that the at least one counterpart 28 has at least one brake counterpart 31, preferably for a friction brake, an electric brake, a hydraulic and/or a magnetic brake, particularly preferably with a brake pad, wherein movement of the second assembly 5 along the second movement direction 9 can be braked by the at least one brake counterpart 31 in conjunction with the at least one blocking element 27, and/or at least one blocking counterpart 32, preferably a bolt receiver for a rotatably and/or slidably mounted bolt, wherein movement of the second assembly 5 along the second movement direction 9 can be blocked by the at least one blocking counterpart 32 in conjunction with the at least one blocking element 27.

According to a preferred embodiment of the guide system 1, it can be provided that the at least one blocking element 27 has at least one blocking piece 30 and the at least one counterpart 28 has at least one blocking counterpart 32, and the at least one blocking element 27 and/or the at least one counterpart 28 has a bevel 33, preferably a beveled surface, wherein the at least one blocking element 27 can pass the at least one counterpart 28 unidirectionally through the at least one bevel 33 during a movement of the two assemblies 4, 5 relative to one another along the second movement direction 9.

According to a preferred embodiment of the guide system 1, it can be provided that the at least one blocking device 10 can be arranged in at least one first blocking position 11, in which a movement of the second assembly 5 along the second movement direction 9 can be blocked, and/or in at least one second blocking position 11, spatially spaced from the first, in which a movement of the second assembly 5 along the second movement direction 9 can be braked.

1. A guide system for movably supporting at least one cover element for covering an opening in a stationary structure, the guide system comprising:
at least one first assembly for arrangement on the stationary structure,
at least one second assembly for arrangement on the at least one cover element,
a first guide device by which the two assemblies can be moved relative to each other in a first movement direction,
a second guide device, by which the two assemblies can be moved relative to each other in a second movement direction transverse, in particular orthogonal, to the first movement direction, and
at least one blocking device configured to be arranged in at least one blocking position, in which a movement of the second assembly along the second movement direction can be braked and/or blocked, and in at least one release position, in which movement of the second assembly along the second movement direction is substantially unaffected by the at least one blocking device.

2. The guide system according to claim 1, wherein the first guide device has at least one, preferably two, and most preferably four, joint devices, by means of which the two assemblies can be brought into at least two joint end positions along the first movement direction, wherein in a second joint end position the two assemblies have a greater distance, preferably between 50 mm and 200 mm, particularly preferably between 100 mm and 150 mm, relative to each other than in a first joint end position, preferably wherein the at least one joint device has at least one toggle lever with at least two straight and/or partially curved toggle lever arms, particularly preferably a pair of toggle levers consisting of a support toggle lever with at least two support toggle lever arms and a drive toggle lever with at least two drive toggle lever arms.

3. The guide system according to claim 1, wherein the second guide device has at least one guide rail and at least one carriage, preferably with at least one roller, by means of which the two assemblies can be brought into at least two rail end positions along the second movement direction, wherein in a first rail end position the two assemblies are arranged substantially in alignment in the direction of view of the first movement direction and in a second rail end position the two assemblies are arranged offset relative to each other in the direction of view of the first movement direction, preferably wherein the first assembly has a first guide rail, the second assembly has a second guide rail, a part of the first guide device is mounted in and/or on the first guide rail so as to be displaceable, and a further part of the first guide device is mounted in and/or on the second guide rail so as to be displaceable.

4. The guide system according to claim 1, wherein the at least one blocking device has at least one blocking element and at least one counterpart, wherein the at least one blocking element is in contact with the at least one counterpart at least in some regions in the at least one blocking position and in the at least one release position is arranged at a distance from the at least one counterpart.

5. The guide system according to claim 4, wherein the at least one blocking element has at least one rotatably and/or slidably mounted brake piece, preferably for a friction brake, an electric brake, a hydraulic and/or a magnetic brake, particularly preferably a brake block, a brake wedge, a brake comb and/or a brake pad, wherein movement of the second assembly along the second movement direction can be braked by the at least one brake piece in conjunction with the at least one counterpart, and/or at least one rotatably and/or slidably mounted blocking piece, preferably a bolt, wherein movement of the second assembly along the second movement direction can be blocked by the at least one blocking piece in conjunction with the at least one counterpart.

6. The guide system according to claim 4, wherein the at least one counterpart has at least one brake counterpart, preferably for a friction brake, an electric brake, a hydraulic and/or a magnetic brake, particularly preferably with a brake pad, wherein movement of the second assembly along the second movement direction can be braked by the at least one brake counterpart in conjunction with the at least one blocking element, and/or at least one blocking counterpart, preferably a bolt receiver for a rotatably and/or slidably mounted bolt, wherein movement of the second assembly along the second movement direction can be blocked by the at least one blocking counterpart in conjunction with the at least one blocking element.

7. The guide system according to claim 4, wherein the at least one blocking element has at least one blocking piece and the at least one counterpart has at least one blocking counterpart, and the at least one blocking element and/or the at least one counterpart has a bevel, preferably a beveled surface, wherein the at least one blocking element can pass the at least one counterpart unidirectionally by means of the at least one bevel during movement of the two assemblies relative to each other along the second movement direction.

8. The guide system according to claim 4, wherein the at least one blocking element is mounted in a part, preferably a carriage, of the first or second guide device in a rotatable and/or displaceable manner, and the at least one counterpart is mounted in a part of the first assembly or in a part of the second assembly, or the at least one counterpart itself is a part of the first assembly or the second assembly.

9. The guide system according to claim 4, wherein the at least one counterpart has at least one, preferably in cross-section, substantially round and/or angular, receiver region with a boundary, preferably wherein the receiver region is an imaginary volume of a recess in the at least one counterpart, wherein the at least one blocking element contacts the boundary at least in one blocking position at least in some regions.

10. The guide system according to claim 4, wherein the at least one blocking device has at least one spring device, preferably a coil spring, wherein the at least one spring device is connected to the at least one blocking element, preferably wherein the at least one blocking element can be pushed at least in some regions into a recess of the at least one counterpart by means of a preloaded spring force of the at least one spring device and/or the at least one blocking element can be displaced at least in some regions out of a recess of the at least one counterpart against a preloaded spring force of the at least one spring device, preferably by means of actuation of an actuator.

11. The guide system according to claim 4, wherein the at least one blocking device has at least one actuator, wherein the at least one blocking device can be brought into the at least one blocking position and/or into the at least one release position by means of the at least one actuator, preferably wherein the at least one actuator is connected directly and/or indirectly via a mediator to the at least one blocking element and/or to the at least one counterpart, by means of which tensile forces and/or compressive forces can be transmitted, and particularly preferably wherein the mediator is a cable.

12. The guide system according to claim 11, wherein the at least one actuator has at least one lever arm, preferably a handle, for actuating the at least one blocking
element, preferably wherein the guide system comprises at least one cover element and the at least one actuator is arranged on the cover element and/or is foldable,
particularly preferred foldable out of the cover element and/or foldable into the cover element, wherein the at least one first guide device comprises at least one joint device, wherein the at least one actuator is at least partially concealed and/or inaccessible in the first joint end position and at least partially visible and/or accessible in the second joint end position.

13. The guide system according to claim 1, wherein the at least one blocking device can be arranged in at least one first blocking position, in which movement of the second assembly along the second movement direction can be blocked, and/or in at least one second blocking position spaced apart from the first, in which movement of the second assembly along the second movement direction can be braked.

14. The guide system according to claim 1, further comprising at least one drive device by which at least one movement of the two assemblies relative to each other, preferably along the first movement direction and/or along the second movement direction, can be driven and/or the at least one blocking device can be driven from at least one blocking position into at least one release position and/or the at least one blocking device can be driven from at least one release position into at least one blocking position.

15. The guide system according to claim 1, wherein the first assembly has at least two, preferably four, first subassemblies and the second assembly has at least two, preferably four, second subassemblies, and the guide system comprises at least one synchronization device for synchronizing a movement of the
subassemblies, preferably wherein the at least one synchronization device comprises at least one synchronization shaft and/or at least one cable pull, preferably wherein the cable pull comprises at least two drive rollers and at least one synchronization cable arranged between the drive rollers, preferably in the form of a figure eight.

16. The guide system according to claim 1, comprising:
at least two guide rails which are connected to the at least one first assembly,
at least one first guide body which is slidably arranged in one of the two guide rails,
at least one second guide body which is slidably arranged in the other of the two guide rails, and
a compensation device for compensating for a tilting moment of a cover element,
wherein the cover element is movable by the guide system between a first position, preferably an open position, and a second position, preferably a displacement position, wherein the compensation device comprises at least one compensation cable, wherein the at least one compensation cable connects the first guide body and the second guide body to each other, and wherein a deflection device is provided by means of which the at least one compensation cable can be guided at least in some regions, preferably in a region between the at least two guide rails, orthogonally to the second movement direction.

17. An arrangement comprising:
a stationary structure, in particular a wall element, with at least one opening,
at least one cover element, with which the at least one opening can be covered at least in regions, and
the guide system according to claim 1, wherein the at least first assembly is arranged on the stationary structure and the at least one second assembly is arranged on the at least one cover element.

18. The arrangement according to claim 17, wherein the first guide device of the guide system has at least one joint device and the second guide device of the guide system has at least one guide rail, wherein
the cover element can be moved from a closed position to an open position by means of the at least one joint device, wherein in the closed position the cover element is arranged at least partially within the at least one opening of the stationary structure and, in the open position, the cover element is arranged outside the at least one opening of the stationary structure, preferably, in the open position, the cover element is spaced substantially orthogonally from the at least one opening of the stationary structure, and
the cover element can be moved from the open position into a displacement position by means of the at least one guide rail, wherein in the displacement position, the cover element is arranged both outside the at least one opening of the stationary structure, preferably spaced substantially orthogonally from the at least one opening of the stationary structure, and is also displaced along the second movement direction relative to the open position and/or closed position.

19. The arrangement according to claim 17, wherein the cover element is a window, a panel and/or a door and, in a closed state, is arranged flush with the stationary structure or partially protruding from the at least one opening of the stationary structure.

20. The arrangement according to claim 17, wherein:
the at least one actuator is arranged on the cover element, preferably on a side of the cover element facing the at least one opening of the stationary structure, and/or on the stationary structure, preferably on a side of the stationary structure facing the cover element, and/or
the at least one actuator can be folded out of the cover element and/or folded out of the stationary structure and/or can be actuated by folding out of the cover element and/or the stationary structure,
preferably the at least one actuator is at least partially concealed and/or inaccessible due to at least one part of the arrangement in the closed position and is at least partially visible and/or accessible in the open position.

21. A method for covering and opening at least one opening in a stationary structure by at least one cover element, comprising:
moving the at least one cover element between a closed position, in which the at least one cover element covers the at least one opening, and an open position in which the cover element is spaced substantially orthogonally from the at least one opening, wherein the movement of the at least one cover element takes place in a first movement direction,
moving the at least one cover element between the open position and a displacement position in which the at least one cover element is arranged laterally offset relative to the opening, wherein the movement of the at least one cover element takes place in a second movement direction transverse, in particular orthogonal, to the first movement direction, and
transferring at least one blocking device from a blocking position, in which the at least one blocking device brakes and/or blocks movement of the at least one cover element along the second movement direction, to at least one release position, in which movement of the at least one cover element along the second movement direction is substantially unaffected by the at least one blocking device, and vice versa.

22. The method according to claim 21, wherein the at least one blocking device must be moved from the blocking position to the at least one release position before movement of the at least one cover element along the second movement direction from the open position toward the displacement position is possible.

23. The method according to claim 21, wherein at least one actuator is provided, by means of which the at least one blocking device is transferred from the blocking position to the release position, wherein the at least one actuator is arranged in a concealed manner in the closed position and is released for actuation when the at least one cover element moves from the closed position to the open position.

24. The method according to claim 21, wherein the method is carried out with the aid of at least one guide system.
